(19) United States
(12) Patent Application Publication
(10) Pub. No.: US 2023/0207956 A1
(43) Pub. Date: Jun. 29, 2023

(54) Battery Cell, And Battery Module, Battery Pack And Vehicle Including The Same

(71) Applicant: LG Energy Solution, Ltd., Seoul (KR)

(72) Inventors: Kyu-Tae Park, Daejeon (KR); Hye-Hyeon Kim, Daejeon (KR); Sang-Seung Oh, Daejeon (KR); Hyeon-Sung Jo, Daejeon (KR)

(73) Assignee: LG Energy Solution, Ltd., Seoul (KR)

(21) Appl. No.: 18/076,840

(22) Filed: Dec. 7, 2022

(30) Foreign Application Priority Data
Dec. 24, 2021 (KR) 10-2021-0187854
Apr. 28, 2022 (KR) 10-2022-0053129

(51) Int. Cl. H01M 50/358; H01M 50/105

(52) U.S. Cl. CPC H01M 50/358; H01M 50/105

(57) ABSTRACT

Disclosed is a battery cell, a battery module, a battery pack, and a vehicle. The battery cell may include a venting guide unit to discharge a venting gas in a desired direction and from a desired location of a cell case of the battery when a thermal event occurs. The battery cell may include an electrode assembly and an electrode lead connected to the electrode assembly. The cell case may be configured to accommodate the electrode assembly therein and support the electrode lead. The venting guide unit provided to the cell case may be configured to guide a venting gas to be discharged to a predetermined region of the cell case as an internal pressure of the cell case increases.

### CROSS-REFERENCE TO RELATED APPLICATIONS

The present application claim priority to Korean Patent Application No. 10-2021-0187854 filed on Dec. 24, 2021, and KR Patent Application No. 10-2022-0053128 fled Apr. 28, 2022, the disclosures of which are incorporated herein by reference in its entirety.

### TECHNICAL FIELD

The present disclosure relates to a battery cell, a battery module, a battery pack and a vehicle including the same, and more particularly, to a battery cell or a battery module with enhanced safety features, a battery pack and a vehicle including the same.

### BACKGROUND ART

Recently, with the rapid increase in demand for portable electronic products such as laptop computers, video cameras and mobile phones and the extensive development of electric vehicles, accumulators for energy storage, robots and satellites, many studies are being conducted on high performance secondary batteries that can be repeatedly recharged.

Currently, commercially available secondary batteries include nickel-cadmium batteries, nickel-hydrogen batteries, nickel-zinc batteries, lithium secondary batteries and the like. Among them, lithium secondary batteries have little or no memory effect, and are gaining more attention than nickel-based secondary batteries as recharging can be done whenever it is convenient. Further, lithium secondary batteries provide a low self-discharge rate with high energy density capability.

The lithium secondary battery mainly uses lithium-based oxide and carbon material as a positive electrode active material and a negative electrode active material, respectively. In addition, the lithium secondary battery includes an electrode assembly in which a positive electrode plate and a negative electrode plate respectively coated with the positive electrode active material and the negative electrode active material are disposed with a separator interposed therebetween, and an exterior for hermetically accommodating the electrode assembly together with an electrolyte.

Meanwhile, depending on the shape of the exterior, lithium secondary batteries may be classified into a can-type secondary battery in which the electrode assembly is included in a metal can and a pouch-type secondary battery in which the electrode assembly is included in a pouch made of an aluminum laminate sheet. In addition, the can-type secondary battery may be further classified into a cylindrical battery and a prismatic battery according to the shape of the metal can.

Here, the pouch of the pouch-type secondary battery may be largely divided into a lower sheet and an upper sheet that covers the lower sheet. At this time, the electrode assembly formed by stacking and winding the positive and negative electrodes and the separator is accommodated in the pouch. In addition, after the electrode assembly is accommodated, the edges of the upper and lower sheets are sealed by thermal fusion. In addition, an electrode tab drawn out from each electrode is coupled to an electrode lead, and an insulating film may be added to the electrode lead at a portion in contact with the sealing portion.

As such, the pouch-type secondary battery may have the flexibility to be configured in various forms. In addition, the pouch-type secondary battery has the advantage of being able to implement a secondary battery of the same capacity with a smaller volume and mass.

The lithium secondary battery is used as a battery module or a battery pack in which several battery cells are overlapped or stacked in the state of being mounted to each other or being mounted to a cartridge or the like to form a dense structure and then electrically connected to each other to provide high voltage and high current.

In the configuration of such a battery pack, one of the most important issues is safety. In particular, when a thermal event occurs in one battery cell among the plurality of battery cells included in the battery pack, propagation of the thermal event to other battery cells needs to be suppressed. If heat propagation between the battery cells is not properly suppressed, this may lead to thermal events of other battery cells included in the battery pack, which may cause greater problems, such as ignition or explosion of the battery pack. Moreover, an ignition or explosion occurring in the battery pack may cause great damage to people or property in the vicinity. Accordingly, in the battery pack, a configuration capable of appropriately controlling the above-described thermal event is required.

### BRIEF SUMMARY OF THE INVENTION

The present disclosure is directed to providing a battery cell, a battery module, a battery pack and a vehicle, which are configured to guide a venting gas to be discharged in a desired direction when a thermal event occurs.

However, the technical object to be solved by the present disclosure is not limited to the above, and other objects not mentioned herein will be clearly understood by those skilled in the art from the following disclosure.

In accordance with an aspect of the present disclosure, a battery cell is provided. A battery cell according to this aspect, may include an electrode assembly, an electrode lead connected to the electrode assembly, a cell case accommodating the electrode assembly and a venting guide unit. A first portion of the electrode lead may be disposed within the cell case and a second portion of the electrode lead may extend away from the cell case. The venting guide unit may be coupled to the cell case. The venting guide unit may include a first slot to receive and secure at least a portion of the first side therewithin. The second portion of the electrode lead may extend through an opening in the venting guide unit. The venting guide unit may be configured to discharge a venting gas through a predetermined region of the cell case as an internal pressure of the cell case increases. The predetermined region may be located adjacent the venting guide unit.

Continuing in accordance with this aspect, the venting guide unit may include a material that is hardened by heat generated from the cell case.

Continuing in accordance with this aspect, the venting guide unit may be configured to induce a venting channel through the predetermined region. The venting gas may be discharged through the venting channel.

Continuing in accordance with this aspect, the cell case may include an accommodation portion and a sealing portion. The accommodation portion may define a volume to accommodate the electrode assembly therein. The sealing portion may extend from the accommodation portion by a predetermined length. The portion of the first side disposed within the first slot of the venting guide unit may include the sealing portion. The predetermined region may be located between the first side and a second side of the cell case adjacent the first side. The predetermined region may be a corner formed between the first and second sides of the cell case.

Continuing in accordance with this aspect, the battery cell may further include a lead film disposed around the electrode lead. The lead film may be being disposed within the first slot of the venting guide unit. The venting guide unit may be disposed around a portion of the electrode lead. The corner may be chamfered.

Continuing in accordance with this aspect, a battery module is provided. A battery module according to this aspect may include the battery cell.

Continuing in accordance with this aspect, a battery pack is provided. A battery pack according to this aspect may include at least one battery module.

Continuing in accordance with this aspect, a vehicle is provided. A vehicle according to this aspect may include at least one battery pack.

In accordance with another aspect of the present disclosure, a battery cell is provided. A battery cell according to this aspect, may include an electrode assembly, an electrode assembly, first and second electrode leads connected to the electrode assembly, a cell case accommodating the electrode assembly, and a first venting guide unit coupled to a first side of the cell case. The first venting guide unit may secure at least a portion of the first side therewithin. The first electrode lead may extend away from the cell case through the first venting guide unit. The first venting guide unit may be configured to discharge a venting gas through a first predetermined region of the cell case as an internal pressure of the cell case increases. The first predetermined region may be located adjacent the first venting guide unit.

Continuing in accordance with this aspect, the battery cell may include a second venting guide unit coupled to a second side of the cell case. The second side may be opposite the first side. The second venting guide unit may secure at least a portion of the second side therewithin. The second electrode lead may extend away from the cell case through the second venting guide unit. The second venting guide unit may be configured to discharge the venting gas through a second predetermined region of the cell case as the internal pressure of the cell case increases. The second predetermined region may be located adjacent the second venting guide unit.

Continuing in accordance with this aspect, the battery cell may include a third venting guide unit coupled to a third side of the cell case extending between the first and second sides. The first predetermined region may be located at a first corner between the first side and an adjacent fourth side. The fourth side may be opposite to the third side. The first corner may be chamfered.

In accordance with another aspect of the present disclosure, a battery cell is provided. A battery cell according to this aspect, may include an electrode assembly, first and second electrode leads connected to the electrode assembly, a cell case accommodating the electrode assembly, a first venting guide unit coupled to a first side of the cell case, a second venting guide unit coupled to a second side of the cell case opposite the first side, and a third venting guide unit coupled to third side of the cell case extending between the first and second sides. The first venting guide unit may secure at least a portion of the first side therewithin. The first electrode lead may extend away from the cell case through the first venting guide unit. The second electrode lead may extend away from the cell case through the second venting guide unit. The first venting guide unit may be configured to discharge a venting gas through a predetermined region of the cell case as an internal pressure of the cell case increases. The predetermined region may be located adjacent the first venting guide unit.

Continuing in accordance with this aspect, the predetermined region may be located at a first corner between the first side and an adjacent fourth side. The fourth side may be opposite the third side.

### Advantageous Effects

According to an embodiment of the present disclosure, since the possibility of a fire occurring inside the battery cell is reduced, the structural stability of the battery cell may be enhanced.

In addition, since the venting gas may be guided to be discharged in a portion of the cell case other than the fragile site to which the venting guide unit is coupled, the venting gas may be discharged in a desired direction.

Moreover, according to various embodiments of the present disclosure, several other additional effects may be achieved. Various effects of the present disclosure will be described in detail in each embodiment, or any effects that can be easily understood by those skilled in the art will not be described in detail.

### DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is an isometric view of a battery cell according to an embodiment of the present disclosure.

FIG. 2 is a front view of the battery cell of FIG. 1.

FIG. 3 is a cross-sectional view of the battery cell of FIG. 1 taken along a line B-B.

FIG. 4 is front view of the battery cell of FIG. 1 showing a venting process.

FIG. 5 is front view of a venting process in a conventional battery cell.

FIG. 6 is graph showing a voltage change and a temperature change along with time for the conventional battery cell of FIG. 5.

FIG. 7 is a front view of a battery cell according to another embodiment of the present disclosure.

FIG. 8 is a front view of a battery cell according to another embodiment of the present disclosure.

FIG. 9 is a front view of a battery cell according to another embodiment of the present disclosure.

FIG. 10 is an isometric view of a battery module with a battery cell of the present disclosure.

FIG. 11 is an isometric view a battery pack including the battery module of FIG. 10.

FIG. 12 is a front view of a vehicle including the battery pack of FIG. 11.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

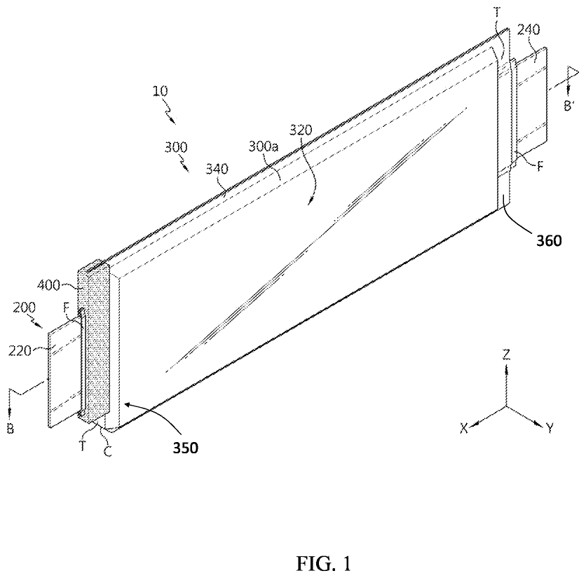

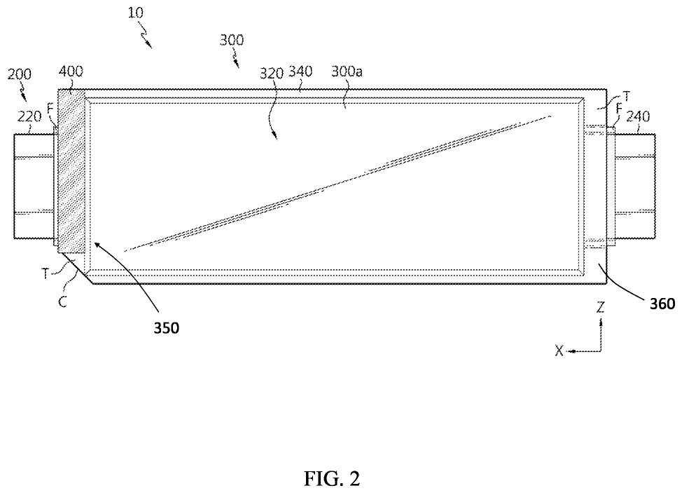

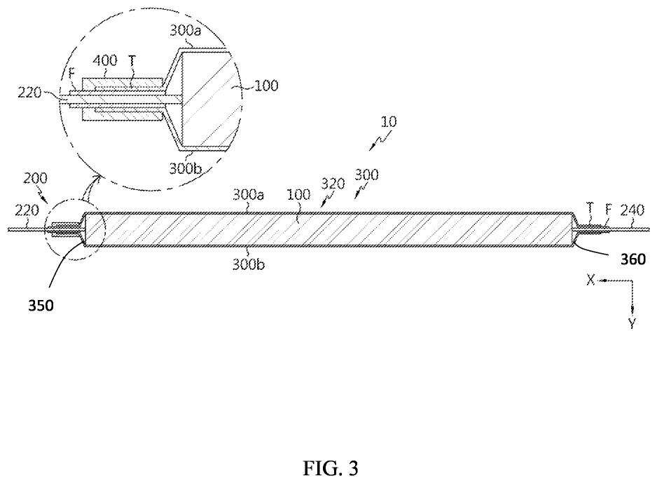

FIG. 1 is a diagram showing a battery cell 10 according to an embodiment of the present disclosure, FIG. 2 is a front view showing the battery cell 10 of FIG. 1, and FIG. 3 is a diagram showing a detailed configuration of the battery cell 10 of FIG. 1. At this time, FIG. 3 is a cross-sectional view showing the battery cell 10 of FIG. 1, taken on the line B-B′ on the XY plane and viewed from the lower side.

In an embodiment of the present disclosure, the X-axis direction shown in the drawings may mean a longitudinal direction of the battery cell 10, the Y-axis direction may mean a front and rear direction of the battery cell 10 perpendicular to the X-axis direction on the horizontal plane (XY plane), and the Z-axis direction may mean an upper and lower direction perpendicular to both the X-axis direction and the Y-axis direction.

Referring to FIGS. 1 to 3, the battery cell 10 according to an embodiment of the present disclosure may include an electrode assembly 100, an electrode lead 200, a cell case 300, and a venting guide unit 400.

The battery cell 10 may be a secondary battery. The battery cell 10 may be a pouch-type battery cell.

Although not shown in detail, the electrode assembly 100 may include a first electrode plate having a first polarity, a second electrode plate having a second polarity, and a separator interposed between the first electrode plate and the second electrode plate. As an example, the first electrode plate may be a positive electrode plate or a negative electrode plate, and the second electrode plate may correspond to an electrode plate having a polarity opposite to that of the first electrode plate.

The electrode lead 200 may be electrically connected to the electrode assembly 100. The electrode lead 200 may be connected to only one side in the longitudinal direction of the electrode assembly 100 or may be connected to both sides.

As an example, the electrode lead 200 may include a first lead 220 and a second lead 240 as shown in FIG. 1. First lead 220 extends away from cell case 300 through a first lateral side 350 and second lead 240 extends away from cell case 300 through a second lateral side 360.

The first lead 220 may be connected to the first electrode plate and may represent a positive polarity or a negative polarity. In addition, the second lead 240 may be connected to the second electrode plate and may represent a positive polarity or a negative polarity.

The cell case 300 may accommodate the electrode assembly 100 therein. That is, the cell case 300 may have an accommodation space for accommodating the electrode assembly 100 therein. At this time, the cell case 300 accommodates an electrolyte therein, and the cell case 300 accommodates the electrode assembly 100 in a state where the electrode assembly 100 is impregnated in the electrolyte. As an example, the cell case 300 may include a metal material (e.g., aluminum (Al)), but is not limited thereto.

In addition, the cell case 300 may be configured to support the electrode lead 200. At this time, the electrode lead 200 may protrude out of the cell case 300 by a predetermined length. Also, a lead film F for sealing the electrode lead 200 and the cell case 300 to each other may be interposed between the electrode lead 200 and the cell case 300 as best shown in FIG. 3.

The venting guide unit 400 is provided to the cell case 300, and may be configured to guide a venting gas to be discharged from a desired region of the cell case 300 as the internal pressure of the cell case 300 increases.

In the battery cell 10 of the present disclosure, an event such as a thermal runaway phenomenon may occur. In this case, a high-temperature and high-pressure venting gas may be generated inside the cell case 300. If the venting gas is randomly discharged from the cell case 300, the likelihood of a fire may increase inside the battery cell 10 as oxygen may be introduced into the cell case 300 through a portion of the cell case 300 where the internal pressure is lowered due to the discharge of the venting gas.

In order to solve this problem, the venting guide unit 400 of the present disclosure may be provided to the cell case 300 to guide the venting gas to be discharged to a predetermined region of the cell case 300. That is, when a thermal runaway phenomenon occurs inside the cell case 300, the venting guide unit 400 may guide and direct the flow of the venting gas to the predetermined portion of the cell case 300. This predetermined portion or region can be adjacent venting guide as shown in FIG. 1.

Accordingly, the venting guide unit 400 may guide the venting gas to be discharged to and through the predetermined region of the cell case 300, which will consequently damage this predetermined region. If a high-pressure venting gas is discharged to a certain region of the cell case 300 in this manner, it is possible to control and minimize the introduction of oxygen into the cell case 300 through the portion of the cell case 300 where the venting gas is discharged—i.e., the predetermined region.

According to this embodiment of the present disclosure, by guiding the venting gas to be discharged to a certain region, the introduction of oxygen into the cell case 300 may be minimized Accordingly, the possibility of a fire occurring inside the battery cell 10 is reduced, and thus the structural stability of the battery cell 10 may be strengthened.

In particular, the venting guide unit 400 may include a material that is hardened due to heat conduction generated as the internal temperature of the cell case 300 rises. As an example, the venting guide unit 400 may include clay that becomes hard when being heated for a specific time, but is not limited thereto.

Meanwhile, a portion of the cell case 300 where the venting guide unit 400 may be a fragile site that is more easily damaged (i.e., by allowing venting gas to breach through) than the rest of cell case 300 by the high-pressure venting gas discharged from the inside of the cell case 300. The fragile site will be described later in more detail.

At this time, the venting guide unit 400 may stably bind the aforementioned fragile site by including a material that is hardened due to heat conduction. Accordingly, the venting guide unit 400 may prevent the venting gas from being discharged to the outside of the cell case 300 through the fragile site.

Hereinafter, the above venting guide unit 400 will be described in more detail.

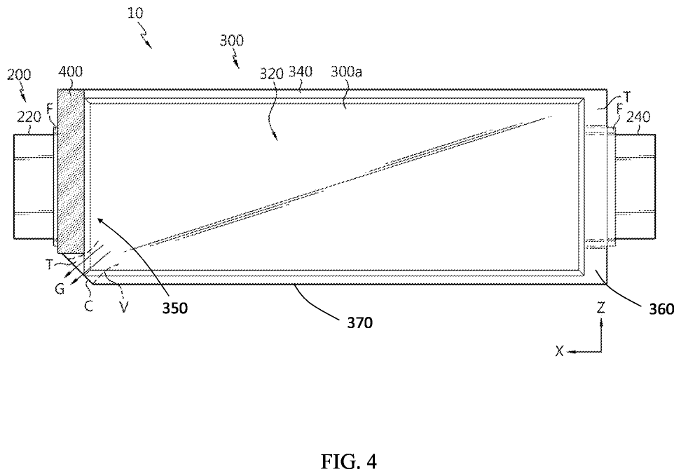

FIG. 4 is a diagram for illustrating a venting process when a thermal runaway phenomenon occurs in the battery cell 10 of FIG. 1. At this time, in FIG. 4, the venting gas is denoted by a reference sign ‘G’.

Referring to FIGS. 1 to 4, the venting guide unit 400 may be coupled to a partial region along lateral side 350 of the surface of the cell case 300 in this embodiment.

At this time, in order to reproduce the thermal runaway environment of the battery cell 10, the temperature of the battery cell 10 was increased from 25° C. to 150° C. at a rate of 5° C./min, and then the battery cell 10 was heated at 150° C. for 1 hour.

As the internal pressure of the cell case 300 increases due to the heating of the battery cell 10, venting guide unit 400 forces a venting channel V to from through which a portion of the cell case 300 to allow for vent gas discharge as shown in FIG. 4. Vent channel V is formed adjacent venting guide 400 on lateral side 350 adjacent a longitudinal side 370 as shown in FIG. 4.

That is, the venting guide unit 400 may guide the flow of the venting gas to be concentrated in a portion of the cell case 300 other than the fragile site (lateral side 350 in FIG. 4) by stably binding the above-described fragile site. Accordingly, the venting guide unit 400 may cause the portion of the cell case 300 other than the fragile site to be damaged to guide the venting gas to be discharged in the portion other than the fragile site.

Referring to FIGS. 1 to 4 again, the cell case 300 may include an accommodation portion 320 configured to accommodate the electrode assembly 100 therein and a sealing portion 340 formed to extend outward by a certain length from the periphery of the accommodation portion 320 around cell case 300. The sealing portion 340 may include a case terrace T on lateral side 350 and lateral side 360. Meanwhile, the cell case 300 may include a first case member 300a and a second case member 300b. Peripheral edges of the first case member 300a and the second case member 300b may be in contact with each other and be coupled to each other by thermal fusion to form the sealing portion 340 described above. A space formed inside the sealing portion 340 by the separation between the first case member 300a and the second case member 300b provides the accommodation portion 320 described above.

The case terrace T may mean a region that is located in a direction along which the electrode lead 200 described above is drawn out of the cell case 300 along the sealing portion 340 of lateral side 350 and lateral side 360.

The case terrace T may be formed to extend by a certain length from the accommodation portion 320 and support the electrode lead 200. At this time, it is possible to seal the electrode lead 200 and the cell case 300 to each other through the lead film F described above. Specifically, the lead film F may be interposed between the electrode lead 200 and the case terrace T.

The portion of the case terrace T supporting the electrode lead 200 may correspond to the fragile site along lateral sides 350, 360 described above. That is, since the electrode lead 200 is interposed between one side (e.g., a front side) and the other side (e.g., a rear side) of the case terrace T, the portion of the case terrace T supporting the electrode lead 200 may be structurally weak compared to the other portion of the cell case 300. In order to reinforce the structural weakness of this fragile site, the venting guide unit 400 may be provided to a region of the case terrace T including the portion where the electrode lead 200 is disposed.

Since the venting guide unit 400 is provided in the portion of the case terrace T supporting the electrode lead 200 as above, it is possible to prevent the venting gas from being discharged through the portion of the cell case 300 where the electrode lead 200 is located, and the venting gas may be guided to be discharged in the region of the cell case 300 except for the portion where electrode lead 200 is located.

In particular, the venting guide unit 400 may be coupled to a portion of the case terrace T where the electrode lead 200 is disposed. As an example, the venting guide unit 400 may be coupled to at least one of a portion of the case terrace T where the first lead 220 is disposed or a portion of the case terrace T where the second lead 240 is disposed.

That is, when the venting guide unit 400 is coupled only to a portion of the case terrace T where the electrode lead 200 is disposed, a smaller venting guide unit 400 can be used.

The venting guide unit 400 may be configured to be coupled over one side of the case terrace T and the other side of the case terrace T with respect to the cell case 300.

Accordingly, in the region of the case terrace T supporting the electrode lead 200, the first case member 300a and the second case member 300b may be more stably bound so that the sealing is not destroyed, and thus it is possible to more reliably prevent the venting gas from being discharged through the region of the cell case 300 where the electrode lead 200 is located or a region adjacent thereto.

In addition, as shown in FIGS. 1 to 3, the venting guide unit 400 may be configured to cover not only a part of the cell case 300 but also a part of the lead film F that is interposed between the electrode lead 200 and the case terrace T. According to this configuration of the present disclosure, it is possible to reliably prevent the sealing force being lowered due to an increase in temperature and/or an increase in internal pressure in the region where the electrode lead 200 is drawn.

The venting guide unit 400 may be configured to cover not only a part of the cell case 300 but also a part of the electrode lead 200 as best shown in FIG. 3. According to this configuration of the present disclosure, it is possible to more reliably prevent the sealing force being lowered due to an increase in temperature and/or an increase in internal pressure in the region where the electrode lead 200 is drawn.

The venting guide unit 400 is configured to facilitate the formation of venting channel V through which the venting gas is discharged in a portion of the case terrace T other than the portion to which the venting guide unit 400 is coupled guide as the internal pressure of the cell case 300 increases. Venting guide unit 400 includes an opening to allow first electrode lead 220 to extending thought the venting guide as best shown in FIG. 1.

As the venting guide unit 400 may be coupled to a partial region of the case terrace T as described above, the venting guide unit 400 may guide the flow of the venting gas to be concentrated to a portion of the case terrace T other than the portion to which the venting guide unit 400 is coupled. Accordingly, the venting channel V may be formed in a portion of the case terrace T other than the portion to which the venting guide unit 400 is coupled.

According to this embodiment of the present disclosure, the venting channel V may be formed in the case terrace T provided at an edge of the cell case 300 formed between lateral side 350 and longitudinal side 370 as best shown in FIG. 4. Therefore, compared to the case where the venting channel V is formed in other portions of the cell case 300, the cell case 300 damage or breach may be minimized, and the venting gas may be more stably and reliably discharged to the outside of the cell case 300.

The venting guide unit 400 may be configured to guide the venting channel V to be formed in the corner portion of the case terrace T as the internal pressure of the cell case 300 increases.

Specifically, as the internal pressure of the cell case 300 increases, the venting channel V may be formed at the corner portion C of the case terrace T located between lateral side 350 and longitudinal side 370. In this case, the venting guide unit 400 may be provided in a region of the case terrace T other than the corner portion C of the case terrace T.

Accordingly, the venting guide unit 400 may further minimize the introduction of oxygen into the cell case 300 by guiding the venting gas to be discharged to the corner portion of the case terrace T, which is a partial region in the case terrace T.

Preferably, the venting channel V may be formed in the corner portion C of the case terrace T located below the electrode lead 200 as the internal pressure of the cell case 300 increases. That is, when the venting channel V is formed in the corner portion C of the case terrace T located below the electrode lead 200, the venting gas is guided to be discharged in the lower direction of the cell case 300, so it is possible to minimize the venting gas flowing back into the cell case 300.

In particular, the case terrace T may be configured such that at least some of the corner portions have a chamfered edge as shown in FIG. 4.

Stress due to build up in internal pressure within cell case 300 may be concentrated at the corner portion of the case terrace T configured with the chamfered edge compared to the other portions of cell case 300. Thus, the venting gas may breach the chamfered edge of the case terrace T on account of the higher stress induced in this region. Accordingly, the venting channel V may be more easily formed through the chamfered edge when the internal pressure of the cell case 300 increases.

In this case, since the venting gas is discharged in the lower direction of the cell case 300, the flow of the venting gas in the upper direction may be suppressed, and the discharge direction of the venting gas may be guided in a more constant direction.

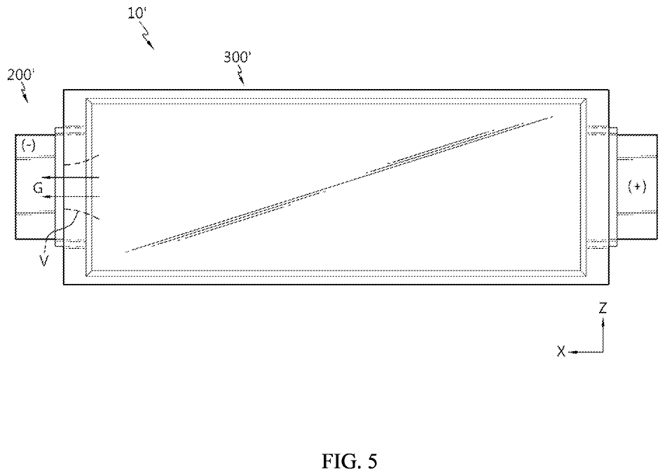

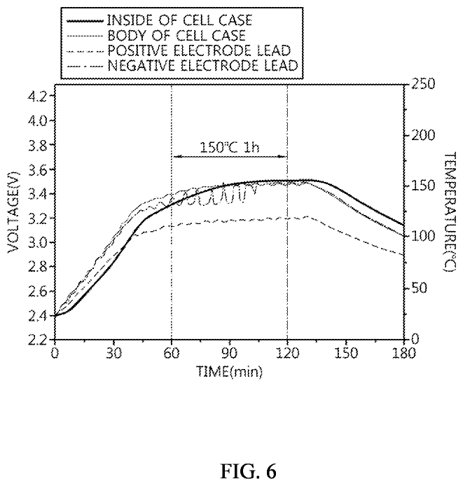

FIG. 5 is a diagram for illustrating a venting process when a thermal runaway phenomenon occurs in a conventional battery cell 10′. FIG. 6 is a diagram for illustrating a voltage change and a temperature change in battery cell 10′ along with time. Venting gas is denoted by a reference sign ‘G.’

Referring to FIG. 5, the conventional battery cell 10′ includes an electrode assembly (not shown), an electrode lead 200′, and a cell case 300′.

In order to reproduce the conventional thermal runaway environment of the battery cell 10′, the temperature of the battery cell 10′ was increased from 25° C. to 150° C. at a rate of 5° C./min, and then the battery cell 10′ was heated at 150° C. for 1 hour.

A venting channel V through which the venting gas is discharged is generated in a portion of the cell case 300′ where the electrode lead 200′ is supported. That is, in the conventional battery cell 10′, the venting gas is discharged toward the electrode lead 200′.

In this case, as shown in FIG. 6, it may be found that the temperature difference and voltage difference between the positive electrode lead and the negative electrode lead of the electrode lead 200′ are large. Thus, when a thermal runaway phenomenon occurs in the battery cell 10′, there is a high possibility that the venting gas is discharged in a region where the negative electrode lead is drawn out from the cell case 300′.

Meanwhile, in the battery cell 10 of the present disclosure, the discharge of the venting gas toward the electrode lead 200 may be suppressed by the venting guide unit 400. For example, when the first lead 220 is configured as a negative electrode lead, the discharge of the venting gas toward the first lead 220 may be suppressed by the venting guide unit 400. Accordingly, the venting guide unit 400 may be preferably coupled to a portion of the case terrace T where the negative electrode lead is disposed.

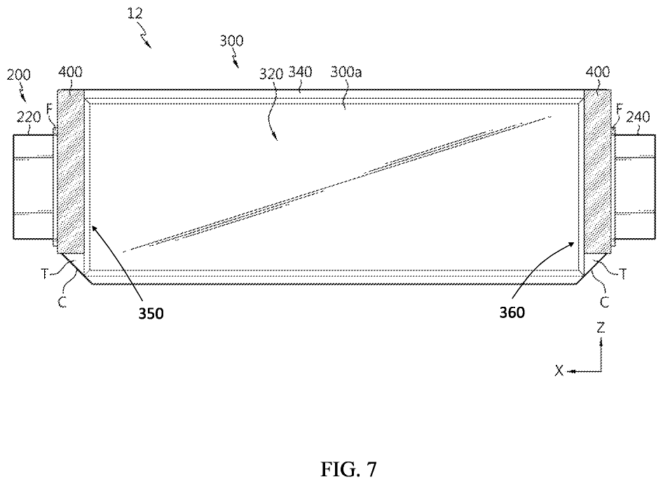

FIG. 7 is a diagram showing a battery cell 12 according to another embodiment of the present disclosure.

Since the battery cell 12 according to this embodiment is similar to the battery cell 10 of the former embodiment, components substantially identical or similar to those of the former embodiment will not be described again, and features different from those of the former embodiment will be described in detail.

Referring to FIG. 7, battery cell 12 includes two venting guide units 400 provided to case terraces T provided at lateral side 350 and lateral side 360 of the cell case 300 in the longitudinal direction.

Specifically, the electrode lead 200 includes a first electrode lead 220 and a second electrode lead 240 provided at opposite lateral sides of the cell case 300 in the longitudinal direction, respectively.

Venting guide units 400 may be coupled to both portions of the case terrace T where the first lead 220 is disposed and a portion of the case terrace T where the second lead 240 is disposed.

In this case, the venting guide units 400 may not only prevent the venting gas from being discharged through the portion of the electrode lead 200 at both sides of the cell case 300 in the longitudinal direction when thermal runaway occurs in the battery cell 12, but can also guide and direct the venting gas to be discharged in the case terraces T located at both lateral sides of the cell case 300 in the longitudinal direction, so that the venting gas may be discharged stably and quickly.

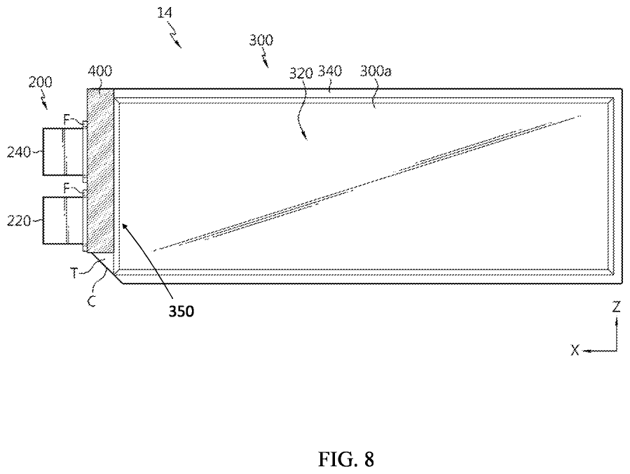

FIG. 8 is a diagram showing a battery cell 14 according to still another embodiment of the present disclosure.

Since the battery cell 14 according to this embodiment is similar to the battery cell 10 of the former embodiment, components substantially identical or similar to those of the former embodiment will not be described again, and features different from those of the former embodiment will be described in detail.

Referring to FIG. 8, battery cell 14 includes electrode lead 200 provided only at one lateral side 350 of the cell case 300 in the longitudinal direction.

Specifically, the electrode lead 200 includes a first electrode lead 220 and a second electrode lead 240 extending through a venting guide unit 400 coupled to lateral side 350 of battery cell 14.

The venting guide unit 400 prevents the venting gas from being discharged through the portion where the first lead 220 and the second lead 240 are located along lateral side 350 of cell case 300. Thus, only a single venting guide unit 400 is needed to cover both electrode leads and is therefore reducing manufacturing cost.

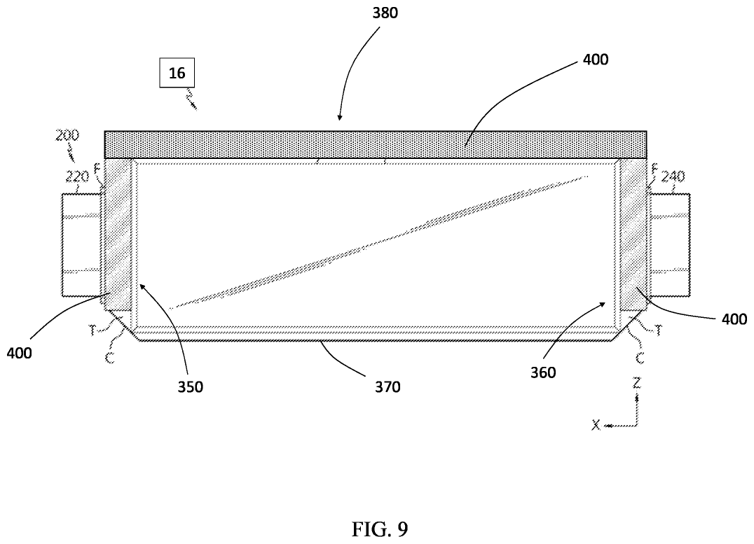

FIG. 9 is a front view of a battery cell 16 according to another embodiment of the present disclosure. Battery cell 16 according to this embodiment is similar to the battery cell 12, components substantially identical or similar to those of the former embodiment will not be described again. For example, battery cell 12 include first and second venting guide units 400 coupled to lateral sides 350 and 360. However, battery cell includes a third venting guide unit 400 disposed along a longitudinal side 380 of cell case 300 as shown in FIG. 14. Longitudinal side 380 is formed by sealing together first case member 300a and second case member 300b, and longitudinal side 370 is formed by folding cell case 300. Thus, third venting guide unit 400 further strengthens peripheral sealing of cell case 300 and ensures that venting gases only breach at the desired locations—i.e., the weakened chamfered edges C. Further, the shape of the chamfered edges ensured that the venting gas are discharged away from the electrode leads 220, 240.

As the possibility of a fire occurring inside the battery cell 10, 12, 14 and 16 is reduced, the structural stability of the battery cell 10, 12, 14, and 16 may be enhanced.

Further, as the discharge of the venting gas may be guided to a portion of the cell case 300 other than the fragile site to which the venting guide unit 400 is coupled, the venting gas may be discharged in the desired location and along a desired exhaust path.

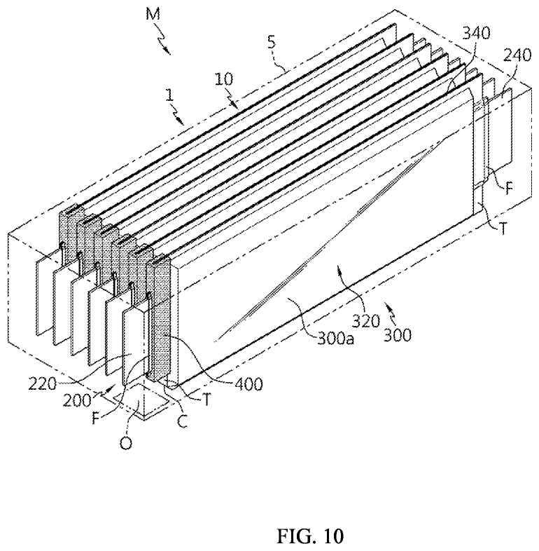

FIG. 10 is a diagram showing a battery module M including the battery cell 10 of the present disclosure.

Referring to FIG. 10, at least one battery cell 10 according to the present disclosure may be provided to configure the battery module M. The battery module M according to the present disclosure may include at least one battery cell 10 according to the present disclosure. The battery cell 10 may include a cell assembly 1, and the cell assembly 1 may be accommodated in a module case 5.

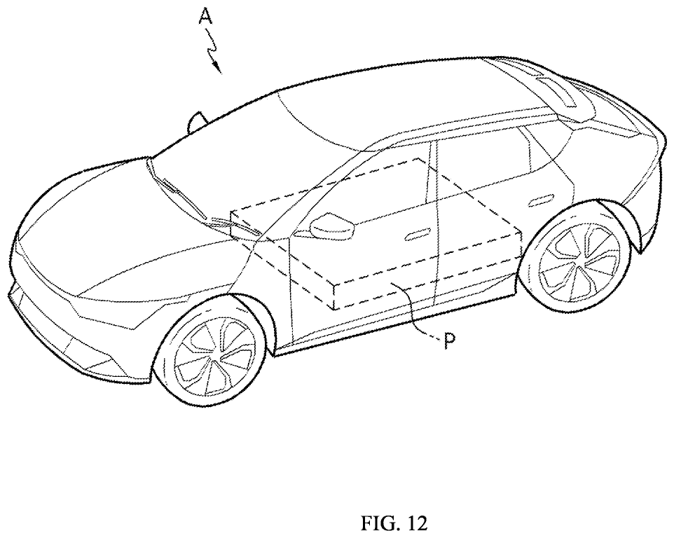

The module case 5 may have a venting hole O formed at a lower side. The venting hole O may be located adjacent to the corner portion C of the case terrace T located below the electrode lead 200. Accordingly, when an event such as the thermal runaway phenomenon occurs in the battery cell 10, the venting gas discharged through the venting path V described above may be easily discharged to the outside of the module case 5 through the venting hole O. In addition, since the venting gas is discharged in the lower direction of the module case 5, it is possible to prevent the venting gas from being discharged toward occupants of a vehicle A (see FIG. 12), as described below.

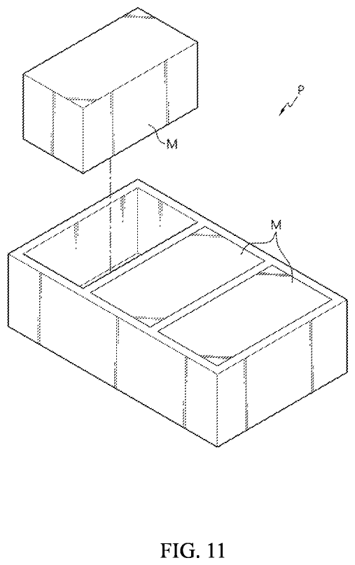

FIG. 11 is a diagram showing a battery pack P including the battery module M of FIG. 10.

Referring to FIG. 11, at least one battery module M according to the present disclosure may be provided to configure the battery pack P. In addition, the battery pack P may further include a pack case for accommodating the battery module M therein and various devices for controlling the charging and discharging of the battery pack P such as a battery management system (BMS), a current sensor, a fuse, etc.

FIG. 12 is a diagram showing a vehicle A including the battery pack P of FIG. 11.

Referring to FIG. 12, the battery pack P according to the present disclosure may be applied to a vehicle A, such as an electric vehicle.

It should be understood that the detailed description and specific examples, while indicating preferred embodiments of the disclosure, are given by way of illustration only, since various changes and modifications within the scope of the disclosure will become apparent to those skilled in the art from this detailed description.

Terms indicating directions such as “upper”, “lower”, “left”, “right”, “front” and “rear” are used herein for convenience only, and it should be obvious to those skilled in the art that these terms may change depending on the position of the stated element or an observer.

Reference Signs

A: vehicle

P: battery pack

M: battery module

1: cell assembly

5: module case

10, 12, 14, 16: battery cell

100: electrode assembly

200: electrode lead

300: cell case

320: accommodation portion

340: sealing portion

T: case terrace

V: venting channel

400: venting guide unit

What is claimed is:

1. A battery cell, comprising:
an electrode assembly;
an electrode lead connected to the electrode assembly;
a cell case accommodating the electrode assembly, a first portion of the electrode lead disposed within the cell case and a second portion of the electrode lead extending away from the cell case, and
a venting guide unit coupled to the cell case, the venting guide unit including a first slot to receive and secure at least a portion of the first side therewithin, the second portion of the electrode lead extending through an opening in the venting guide unit,
wherein the venting guide unit is configured to discharge a venting gas through a predetermined region of the cell case as an internal pressure of the cell case increases, the predetermined region being located adjacent the venting guide unit.

2. The battery cell according to claim 1, wherein the venting guide unit includes a material that is hardened by heat generated from the cell case.

3. The battery cell according to claim 1, wherein the venting guide unit is configured to induce a venting channel through the predetermined region, the venting gas being discharged through the venting channel.

4. The battery cell according to claim 1, wherein the cell case includes an accommodation portion and a sealing portion, the accommodation portion defining a volume to accommodate the electrode assembly therein, the sealing portion extending from the accommodation portion by a predetermined length, the portion of the first side disposed within the first slot of the venting guide unit includes the sealing portion.

5. The battery cell according to claim 4, wherein the predetermined region is located between the first side and a second side of the cell case adjacent the first side.

6. The battery cell according to claim 5, wherein the predetermined region is a corner formed between the first and second sides of the cell case.

7. The battery cell according to claim 6, further including a lead film disposed around the electrode lead, the lead film being disposed within the first slot of the venting guide unit.

8. The battery cell according to claim 6, wherein the venting guide unit is disposed around a portion of the electrode lead.

9. The battery cell according to claim 6, wherein the corner is chamfered.

10. A battery module, comprising a battery cell according to claim 1.

11. A battery pack, comprising at least one battery module according to claim 10.

12. A vehicle, comprising at least one battery pack according to claim 11.

13. A battery cell, comprising:
an electrode assembly;
first and second electrode leads connected to the electrode assembly;
a cell case accommodating the electrode assembly, and
a first venting guide unit coupled to a first side of the cell case, the first venting guide unit securing at least a portion of the first side therewithin, the first electrode lead extending away from the cell case through the first venting guide unit,
wherein the first venting guide unit is configured to discharge a venting gas through a first predetermined region of the cell case as an internal pressure of the cell case increases, the first predetermined region being located adjacent the first venting guide unit.

14. The battery cell according to claim 13, further including a second venting guide unit coupled to a second side of the cell case, the second side being opposite to the first side.

15. The battery cell according to claim 14, wherein the second venting guide unit secures at least a portion of the second side therewithin, the second electrode lead extending away from the cell case through the second venting guide unit, the second venting guide unit being configured to discharge the venting gas through a second predetermined region of the cell case as the internal pressure of the cell case increases, the second predetermined region being located adjacent the second venting guide unit.

16. The battery cell according to claim 15, further including a third venting guide unit coupled to a third side of the cell case extending between the first and second sides.

17. The battery cell according to claim 16, wherein the first predetermined region is located at a first corner between the first side and an adjacent fourth side, the fourth side being opposite to the third side.

18. The battery cell according to claim 17, wherein the first corner is chamfered.

19. A battery cell, comprising:
an electrode assembly;
first and second electrode leads connected to the electrode assembly;
a cell case accommodating the electrode assembly;
a first venting guide unit coupled to a first side of the cell case, the first venting guide unit securing at least a portion of the first side therewithin, the first electrode lead extending away from the cell case through the first venting guide unit;
a second venting guide unit coupled to a second side of the cell case opposite the first side, the second electrode lead extending away from the cell case through the second venting guide unit, and
a third venting guide unit coupled to third side of the cell case extending between the first and second sides,
wherein the first venting guide unit is configured to discharge a venting gas through a predetermined region of the cell case as an internal pressure of the cell case increases, the predetermined region being located adjacent the first venting guide unit.

20. The battery cell according to claim 19, wherein the predetermined region is located at a first corner between the first side and an adjacent fourth side, the fourth side being opposite to the third side.
